(19) United States
(12) Patent Application Publication
(10) Pub. No.: US 2026/0114651 A1
(43) Pub. Date: Apr. 30, 2026

(54) TELESCOPIC ROD

(71) Applicant: Shandong Yijiale Smart Home Technology Co., Ltd., Yantai City (CN)

(72) Inventor: Zengjie Yu, Longkou City (CN)

(21) Appl. No.: 19/432,895

(22) Filed: Dec. 24, 2025

(30) Foreign Application Priority Data
Sep. 30, 2025 (CN) 202522111200.0

(51) Int. Cl. A47H 1/022; A47H 1/02

(52) U.S. Cl. CPC A47H 1/022; A47H 2001/0205; A47H 2001/0215

(57) ABSTRACT

A telescopic rod comprising an inner tube and an outer tube mutually sleeved, wherein the inner tube is provided with a base body at one end positioned within the outer tube and an installation column at one end facing the outer tube. The installation column is sleeved outside an elastic expansion member. The elastic expansion member has a number of circumferentially distributed expansion portions. The expansion portions, which can retract toward or expand away from the central axis of the elastic member, enable fine-tuning of the spacing between the inner and outer tubes.

### TECHNICAL FIELD

The present disclosure relates to the technical field of telescopic rods, particularly to a telescopic rod.

### BACKGROUND

Manual telescopic rods have a wide range of applications, such as window curtain rods and door curtain rods. Two rod-shaped members are mutually sleeved, allowing for a relative sliding movement between them. A locking mechanism is provided between the two rod-shaped members. The two rod-shaped members are locked by the locking mechanism after being mutually retracted or expanded so as to achieve a telescopic function of the telescopic rod. For example, a locking structure of a telescopic rod disclosed by the Chinese patent with a publication number CN208951048U is complex in structure by disposing a connection locking sleeve at a joint between an outer tube and an inner tube and locking the connection locking sleeve by an installation bolt. Moreover, the external locking structure affects the overall integrity of the telescopic rod.

### SUMMARY

An objective of the present disclosure is to design a telescopic rod to address the shortcomings of the prior art.

The present disclosure provides a telescopic rod including an inner tube and an outer tube mutually sleeved, wherein the inner tube is provided with a base body at one end positioned within the outer tube and an installation column at one end facing the outer tube; the installation column is provided with an installation hole coaxial with the inner tube at an end portion; the installation hole is internally provided with a limit rod; an elastic expansion member is sleeved outside the installation column and positioned within the outer tube; the elastic expansion member is in screw connection with a periphery of the installation column and has a number of circumferentially distributed expansion portions; the circumferentially distributed expansion portions may be retracted toward or expanded away from an axial center of the elastic expansion member; outer walls of the expansion portions are engaged against an inner wall of the outer tube, enabling the elastic expansion member to rotate together with the outer tube; a conical portion is sleeved on the limit rod and positioned among the expansion portions and is capable of moving in an axial direction along the limit rod; one end of the conical portion with smaller radial dimension faces a bottom of the elastic expansion member; when the outer tube and the inner tube forwards rotate in the axial direction, the outer tube or the base body drives the elastic expansion member to rotate so as to make the elastic expansion member and the installation column rotate relative to each other, thereby enabling the elastic expansion member to move in the axial direction towards one end of the conical portion with larger radial dimension; the conical portion gradually expands the expansion portions until the expansion portions are tightly engaged against the inner wall of the outer tube; at which point the outer tube and the inner tube become mutually locked; and an elastic member is sleeved on the limit rod and positioned at the end of the conical portion with larger radial dimension and the limit rod, such that the conical portion elastically moves in the axial direction relative to the limit rod; and

when the inner tube and the outer tube are inverted relative to the axial direction, the outer tube, together with the elastic expansion member, rotates so as to make the elastic expansion member move in the axial direction towards the end of the conical portion with small radial dimension and the expansion portions of the elastic expansion member be gradually inwards retracted, such that the elastic expansion member is disengaged from the inner wall of the outer tube, and at which point the outer tube and the inner tube are mutually unlocked.

Preferably, an internal thread is disposed within the installation hole, and an external thread is disposed on the limit rod, so as to allow the limit rod to be screwed onto the installation hole.

Further preferably, the elastic expansion member includes a base and expansion portions connected to the base, and a threaded hole in screw connection with the installation column is provided in the base.

Further preferably, the expansion portions are block bodies made of plastics, inner walls of the expansion portions are arc-shaped surfaces adapted to an outer peripheral wall of the conical portion, and adjacent expansion portions are distributed at intervals.

Preferably, the elastic member is a spring, the spring is sleeved on the limit rod, a limit end is formed at one end of the limit rod facing the outer tube, one end of the spring is engaged against the limit end and the other end thereof is engaged against the end of the conical portion with larger radial dimension, and when the spring is in an unpressurized state, a length dimension of the limit rod at a portion where the spring is located is smaller than a sum of lengths of a portion where the conical portion is located and a portion where the installation column is located.

Further preferably, a thread is disposed on a periphery of the installation column, and provided with a stop portion at the bottom of the installation column, so as to prevent the base from being screwed to the installation column into a seized state.

Preferably, the conical portion is a frustum-shaped body composed of two radially-half blocks joined together, half-hole structures are disposed on the two blocks, the half-hole structures of the two blocks are joined together to form a complete circular hole structure, and the conical portion is sleeved on the limit rod through the circular hole structure.

Preferably, end portions of both the inner tube and the outer tube mutually sleeved are straight tube segments, and the base body, the installation column, the limit rod, the elastic expansion member, the conical portion and the elastic member are all positioned in the respective straight tube segments.

Further preferably, tube segments of the inner tube and the outer tube except for the straight tube segments are either straight or curved tube segments.

The present disclosure has the technical effect that the inner tube is provided with the base body at an end portion extending into the outer tube; the installation column is disposed on the base body; the elastic expansion member is sleeved on the installation column; the conical portion is disposed at a center of the elastic expansion member; the frustum-shaped structure in which a diameter of one end is greater than that of the other end is formed on a peripheral wall of the conical portion; a static friction is formed between the elastic expansion member and the inner wall of the outer tube; when the outer tube rotates in the axial direction toward one direction, the outer tube drives the elastic expansion member to rotate; the elastic expansion member moves in the axial direction towards a top of the installation column; and the elastic expansion member is in contact with the outer wall of the conical portion and moves in the axial direction along the conical portion. Due to a gradual trend of the peripheral wall of the conical portion, the elastic expansion member is gradually expanded to ensure that the elastic expansion member is tightly engaged against the inner wall of the outer tube, at which point the elastic portion is tightly engaged with the outer tube, and thus the outer tube and the inner tube are locked. When the inner tube and the outer tube are unlocked, the outer tube or the inner tube rotates in the axial direction toward the other direction, and the outer tube drives the elastic expansion member to rotate or the base body drives the elastic expansion member to rotate in the axial direction; and the elastic expansion member moves in the axial direction towards a bottom of the conical portion, at which point the elastic expansion member is gradually retracted, and the elastic expansion member is disengaged from the inner wall of the outer tube. Therefore, the inner tube and the outer tube may be locked at any position after being retracted or expanded. The telescopic rod is simple in structure without being excessively machined. Moreover, the telescopic rod is stably locked. The elastic member is sleeved on the limit rod. One end of the elastic member is engaged against an end surface of the conical portion and the other end of the elastic member is engaged against one end of the limit rod, such that the conical portion may be elastically limited when moving in the axial direction along the limit rod. In this way, when the elastic expansion member moves until the inner tube and the outer tube are locked, the conical portion may still compress the elastic member for a certain distance. Such a movement process is relatively slow, thereby fine-tuning a spacing between the inner tube and the outer tube when the inner tube and the outer tube are expanded, such that a certain spacing between the inner tube and the outer tube may be fine-tuned and the risk of seizure is eliminated.

### BRIEF DESCRIPTION OF THE DRAWINGS

FIG. 1 is an exploded view of an overall structure according to an embodiment 1.

FIG. 2 is a sectional view of an overall structure according to an embodiment 1.

FIG. 3 is a view of a block structure according to an embodiment 1.

FIG. 4 is a structural sectional view when an inner tube and an outer tube are in an expanded state according to an embodiment 2.

FIG. 5 is a structural sectional view when an inner tube and an outer tube are in a retracted state according to an embodiment 2.

In the figures: 1, inner tube; 2, outer tube; 3, base body; 4, installation column; 41, installation hole; 42, thread; 43, internal thread; 5, limit rod; 51, limit end; 52, external thread; 6, elastic expansion member; 61, base; 62, expansion portion; 63, threaded hole; 7, conical portion; 71, circular hole structure; 72, block; 73, half-hole structure; 9, stop portion; 10, elastic member; and 11, straight tube segment.

### DESCRIPTION OF THE EMBODIMENTS

Technical solutions in embodiments of the present disclosure will be clearly and completely described below in conjunction with accompanying drawings. Obviously, the described embodiments are only some embodiments of the present disclosure, rather than all the embodiments. Based on embodiments of the present disclosure, all other embodiments obtained by those skilled in the art are within the scope of protection of the present disclosure.

### Embodiment 1

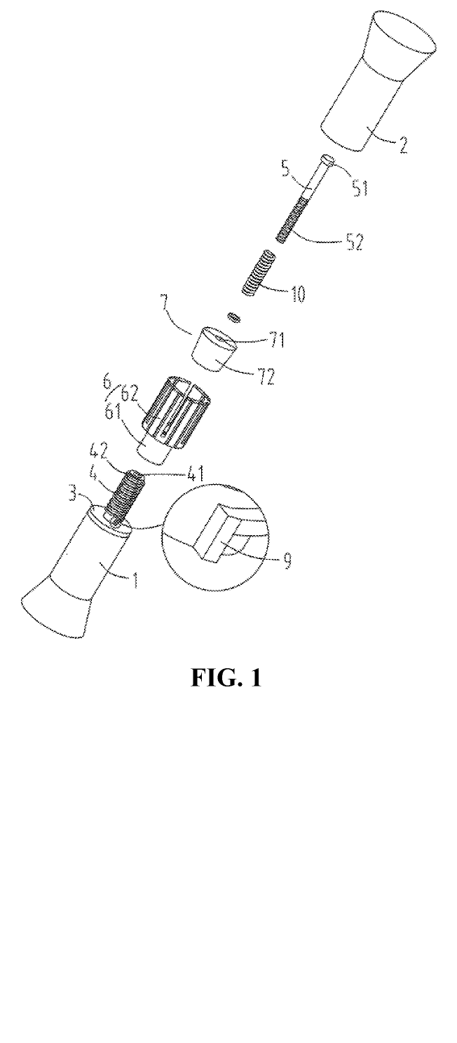

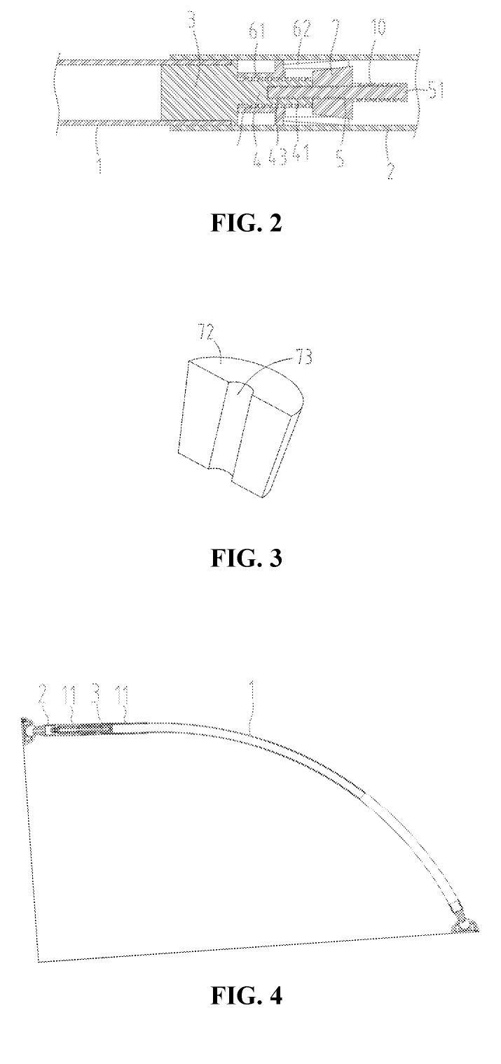

As shown in FIG. 1 and FIG. 2, the present disclosure includes an inner tube 1 and an outer tube 2 mutually sleeved. The inner tube 1 is provided with a base body 3 at one end positioned within the outer tube 2. Both the inner tube 1 and the outer tube 2 adopt a circular tube structure. Correspondingly, the base body 3 is of a columnar structure, such that the base body 3 may be inserted into an end portion of the inner tube 1. A limit structure is disposed between the base body 3 and the inner tube 1, such that the base body 3 is fixedly connected to the inner tube 1. The base body 3 is provided with an installation column 4 at an end surface facing the outer tube 2, and the installation column 4 and the base body 3 are integrally arranged. The installation column 4 is provided with an installation hole coaxial with the inner tube 1 at an end portion, and a limit rod 5 is disposed within the installation hole 41. The limit rod 5 may be screwed into the installation hole 41 and fixed in a manner of applying glue so as to prevent the limit rod 5 from being disengaged from the installation hole 41. Certainly, further commonly used connection methods may be used. In summary, the limit rod 5 needs to be stably installed within the installation hole 41 to avoid the disengagement from the installation hole 41 during long-term use. The elastic expansion member 6 is sleeved outside the installation column 4 and positioned within the outer tube 2. The elastic expansion member 6 includes a base 61 and expansion portions 62 connected to the base 61. A threaded hole 63 in screw connection with a periphery of the installation column 4 is provided in the base 61.

A number of expansion portions 62 are distributed in a circular array around the elastic expansion member 6, and may be simultaneously retracted or expanded along an axis center of the elastic expansion member 6. Outer walls of the expansion portions 62 are engaged against the inner wall of the outer tube 2, creating a static friction between the expansion portions 62 and the inner wall of the outer tube 2. Therefore, the elastic expansion member 6 may rotate together with the outer tube 2.

A conical portion 7 is sleeved on the limit rod 5 and positioned among a number of expansion portions 62 and may move in an axial direction along the limit rod 5. In this embodiment, the conical portion 7 is a frustum-shaped block body with a circular hole structure 71 at a center. The conical portion 7 is sleeved on the limit rod 5 through the circular hole structure 71. A peripheral wall of the conical portion 7 is in contact with the inner wall of the outer tube 2. One end of the conical portion 7 with smaller radial dimension faces the bottom of the elastic expansion member 6. When the outer tube 2 and the inner tube 1 rotate relative to each other, two types of rotation are included. The first type of rotation is defined as a forward rotation, that is, the outer tube 2 or the inner tube 1 rotates towards one direction. When the outer tube 2 rotates, the outer tube 2 drives the elastic expansion member 6 to rotate together so as make the elastic expansion member 6 and the installation column 4 rotate relative to each other, thereby enabling the elastic expansion member 6 to move in the axial direction towards one end of the conical portion 7 with larger diameter. The conical portion 7 gradually expands the expansion portions 62, until the expansion portions 62 are tightly engaged against the inner wall of the outer tube 2, at which point the outer tube 2 and the inner tube 1 are mutually locked. When the inner tube 1 rotates, the inner tube 1 drives the base body 3 to rotate, and the elastic expansion member 6 rotates together with the base body 3. Similarly, the elastic expansion member 6 and the installation column 4 rotate relative to each other, which may achieve that the inner tube 1 and the outer tube 2 are mutually locked, at which point no adjustment is made between the inner tube 1 and the outer tube 2.

The second type of rotation is defined as an inverted rotation, that is, the inner tube 1 or the outer tube 2 rotates in another direction, opposite to the forward rotation, that is, the outer tube 2 rotates in an opposite direction, or the inner tube 1 rotates in the opposite direction, and the outer tube 2 rotates together with the elastic expansion member 6, which makes the elastic expansion member 6 and the installation column 4 rotate in the opposite directions, thereby enabling the elastic expansion member 6 to move in the axial direction towards one end of the conical portion 7 with smaller diameter. The expansion portions 62 of the elastic expansion member 6 are gradually retracted inwards, such that the elastic expansion member 6 is disengaged from the inner wall of the outer tube 2, at which point the outer tube 2 and the inner tube 1 are mutually locked, and at this time, a relative distance between the inner tube 1 and the outer tube 2 may be adjusted. In this way, retraction and expansion may be achieved as the telescopic rod.

An elastic member 10 is sleeved on the limit rod 5. In this embodiment, the elastic member 10 adopts a spring sleeved on the limit rod 5. A limit end 51 is formed at one end of the limit rod 5 facing the outer tube 2. One end of the spring is engaged against the limit end 51 and the other end thereof is engaged against the end of the conical portion 7 with larger diameter, such that the conical portion 7 may be elastically limited when moving in the axial direction along the limit rod 5. A purpose of disposing the elastic member 10 is that when the elastic expansion member 6 rotates to the end of the conical portion 7 with larger diameter, due to an elastic force of the elastic member 10, the conical portion 7 moves for a certain distance towards the limit end 51 of the limit rod 5 under the driving of the elastic expansion member 6. In this way, a certain buffer path is formed to prevent the conical portion 7 from being directly engaged against the limit end 51 and further being completely locked. Such a buffer movement path formed provides a fine-tuning range for the spacing between the outer tube 2 and the inner tube 1, that is, when the outer tube 2 and the inner tube 1 are retracted or expanded relative to each other, two stages are included. The first stage is that the elastic expansion member 6 moves along the conical portion 7, is gradually expanded by the conical portion 7 until the maximum angle is achieved. In this way, the outer tube 2 is tightly engaged against the expansion portions 62. Such a stage is called coarse tuning, which means that retraction or expansion tuning is referred to as the coarse tuning. After the first stage, due to the presence of the elastic member 10, the conical portion 7 extrudes the elastic member 10 and continues to move along with the elastic expansion portion 62. However, under a reaction force of the elastic member 10, such a movement is relatively slow. Therefore, such a stage is called fine tuning, which means that the fine tuning is followed by the retraction or expansion course tuning.

Further, the elastic member 10 is located between one end of the conical portion 7 with larger radial dimension and the limit rod 5, such that the conical portion 7 may elastically move along the axial direction relative to the limit rod 5.

Further, an internal thread 43 is disposed within the installation hole 41, and an external thread 52 is disposed on the limit rod 5, so as to enable the limit rod 5 to be screwed onto the installation hole 41.

Further, the expansion portions 62 are blocks made of plastics, inner walls of the expansion portions 62 are arc-shaped surfaces adapted to an outer peripheral wall of the conical portion 7, and adjacent expansion portions 62 are distributed at intervals, such that the expansion portions 62 may elastically deform relative to the base 61, forming synchronous expansion and retraction actions.

Further, when the spring is in an unpressurized state, a length dimension of the limit rod 5 at a portion where the spring is located is smaller than a sum of lengths of a portion where the conical portion 7 is located and a portion where the installation column 4 is located. In this way, a connection portion between the limit rod 5 and the installation column 4 is longer, enabling the limit rod 5 to be more stably fixed and preventing the limit rod 5 from displacing and loosening when the elastic rod is extruded.

Further, a thread 42 is disposed on a periphery of the installation column 4, and provided with a stop portion 9 at the bottom of the installation column 4, so as to prevent the base 61 from being screwed to the installation column 4 into a seized state.

Further, as shown in FIG. 3, the conical portion 7 is composed of two radially-half blocks 72 joined together. Half-hole structures 73 are disposed on the two blocks 72. The half-hole structures 73 of the two blocks 72 are joined together to form a complete circular hole structure 71. The conical portion 7 is sleeved on the limit rod 5 through the circular hole structure 71. The conical portion 7 may not be disengaged from the expansion portions 62 because of being limited by the expansion portions 62.

Certainly, a limit mechanism is disposed between the inner tube 1 and the outer tube 2 to prevent separation caused by excessively tuning a relative distance after the inner tube 1 and the outer tube 2 are mutually unlocked.

In this embodiment, both the inner tube 1 and the outer tube 2 are straight tube structures, such that the inner tube 1 and the outer tube 2 may be straightly retracted or expanded.

### Embodiment 2

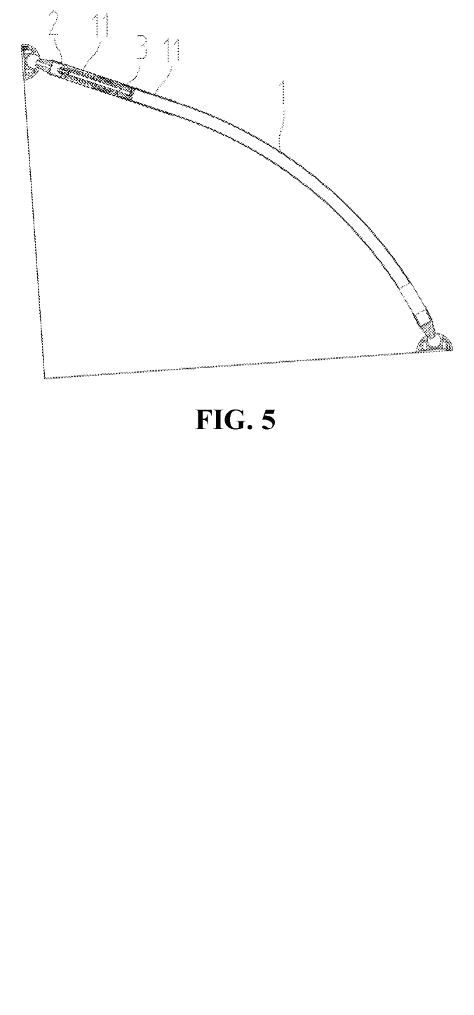

The embodiment 2 is substantially the same as the embodiment 1, with a difference that, as shown in FIG. 4 and FIG. 5, the inner tube 1 and the outer tube 2 may be of a curved tube structure, such that the inner tube 1 and the outer tube 2 are mutually sleeved to form a curved telescopic tube structure, provided that end portions of both the inner tube 1 and the outer tube 2 mutually sleeved are straight tube segments 11, the base body 3 is installed on the straight tube segment 11 of the inner tube 1, and the installation column 4, the limit rod 5, the elastic expansion member 6, the conical portion 7 and the elastic member 10 are all positioned on the respective straight tube segments 11. In this way, when the inner tube 1 and the outer tube 2 are retracted or expanded, reciprocal retraction or expansion may be achieved provided that the end portions of both the inner tube 1 and the outer tube 2 mutually sleeved are the straight tube segments 11. However, tube segments of the inner tube 1 and the outer tube 2 except for the straight tube segments 11 are of the curved tube structures. As such, the curved telescopic tube structure may be achieved, and may be used at a corner as a curtain rod.

What is claimed is:

1. A telescopic rod, comprising an inner tube and an outer tube mutually sleeved, wherein the inner tube is provided with a base body at one end positioned within the outer tube and an installation column at one end facing the outer tube; the installation column is provided with an installation hole coaxial with the inner tube at an end portion; the installation hole is internally provided with a limit rod; an elastic expansion member is sleeved outside the installation column and positioned within the outer tube; the elastic expansion member is in screw connection with a periphery of the installation column and has a number of circumferentially distributed expansion portions; the circumferentially distributed expansion portions may be retracted toward or expanded away from an axial center of the elastic expansion member; outer walls of the expansion portions are engaged against an inner wall of the outer tube, enabling the elastic expansion member to rotate together with the outer tube; a conical portion is sleeved on the limit rod and positioned among the expansion portions and is capable of moving in an axial direction along the limit rod; one end of the conical portion with smaller radial dimension faces a bottom of the elastic expansion member; when the outer tube and the inner tube forwards rotate in the axial direction, the outer tube or the base body drives the elastic expansion member to rotate so as to make the elastic expansion member and the installation column rotate relative to each other, thereby enabling the elastic expansion member to move in the axial direction towards one end of the conical portion with larger radial dimension; the conical portion gradually expands the expansion portions until the expansion portions are tightly engaged against the inner wall of the outer tube; at which point the outer tube and the inner tube become mutually locked; and an elastic member is sleeved on the limit rod and positioned at the end of the conical portion with larger radial dimension and the limit rod, such that the conical portion elastically moves in the axial direction relative to the limit rod; and
when the inner tube and the outer tube are inverted relative to the axial direction, the outer tube, together with the elastic expansion member, rotates so as to make the elastic expansion member move in the axial direction towards the end of the conical portion with small radial dimension and the expansion portions of the elastic expansion member be gradually inwards retracted, such that the elastic expansion member is disengaged from the inner wall of the outer tube, and at which point the outer tube and the inner tube are mutually unlocked.

2. The telescopic rod according to claim 1, wherein an internal thread is disposed within the installation hole, and an external thread is disposed on the limit rod, so as to allow the limit rod to be screwed onto the installation hole.

3. The telescopic rod according to claim 2, wherein the elastic expansion member comprises a base and expansion portions connected to the base, and a threaded hole in screw connection with the installation column is provided in the base.

4. The telescopic rod according to claim 3, wherein the expansion portions are block bodies made of plastics, inner walls of the expansion portions are arc-shaped surfaces adapted to an outer peripheral wall of the conical portion, and adjacent expansion portions are distributed at intervals.

5. The telescopic rod according to claim 1, wherein the elastic member is a spring, the spring is sleeved on the limit rod, a limit end is formed at one end of the limit rod facing the outer tube, one end of the spring is engaged against the limit end and the other end thereof is engaged against the end of the conical portion with larger radial dimension, and when the spring is in an unpressurized state, a length dimension of the limit rod at a portion where the spring is located is smaller than a sum of lengths of a portion where the conical portion is located and a portion where the installation column is located.

6. The telescopic rod according to claim 3, wherein a thread is disposed on a periphery of the installation column, and provided with a stop portion at the bottom of the installation column, so as to prevent the base from being screwed to the installation column into a seized state.

7. The telescopic rod according to claim 1, wherein the conical portion is a frustum-shaped body composed of two radially-half blocks joined together, half-hole structures are disposed on the two blocks, the half-hole structures of the two blocks are joined together to form a complete circular hole structure, and the conical portion is sleeved on the limit rod through the circular hole structure.

8. The telescopic rod according to claim 1, wherein end portions of both the inner tube and the outer tube mutually sleeved are straight tube segments, and the base body, the installation column, the limit rod, the elastic expansion member, the conical portion and the elastic member are all positioned in the respective straight tube segments.

9. The telescopic rod according to claim 8, wherein tube segments of the inner tube and the outer tube except for the straight tube segments are either straight or curved tube segments.
